(19) United States
(12) Patent Application Publication
(10) Pub. No.: US 2006/0019546 A1
(43) Pub. Date: Jan. 26, 2006

(54) Coupling, line, arrangement comprising the same, method of producing the same as well as method of connecting and disconnecting lines

(75) Inventors: Karl Haschka, Grundau (DE); Arthur Poppel, Gelnhausen (DE); Thomas Rosch, Linsengericht-Waldrode (DE); Sergio Pascuzzi, Griesheim (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: VERITAS AG, Gelnhausen (DE)

(21) Appl. No.: 11/176,330

(22) Filed: Jul. 8, 2005

(30) Foreign Application Priority Data
Jul. 9, 2004 (DE) 10 2004 033 349.1

(51) Int. Cl. H01R 24/00

(52) U.S. Cl. 439/660

(57) ABSTRACT

The present invention relates to a coupling, in particular a quick coupling, for connecting lines, said coupling comprising a first connection area and at least one second connection area, said first connection area being provided, at least sectionwise, with a section which is adapted to the contour thereof. Said section comprises energetically activatable particles and is adapted to be brought into contact with a line end of one of the lines to be connected.

The present invention relates to a coupling for connecting lines, comprising a first connection area and at least one second connection area. The invention additionally relates to a line, in particular for connection to a coupling, comprising a first line end, to an arrangement comprising a coupling and a line, and to an arrangement comprising two lines. Furthermore, the invention relates to a method of producing a coupling and a line, respectively, and to a method for connecting and disconnecting lines.

Couplings used for connecting lines and comprising a first connection area and at least one second connection area are known and marketed e.g. by the applicant. Such couplings are especially used in the field of automobile industry for connecting fuel hoses. In this respect, it is important to establish a mechanical firm connection, which is so safe that, in the case of an accident, a destruction of the hose connection will be avoided to a large extent. In addition, the hose connection must be leakproof to such an extent that fuel cannot escape in the area of the connection due to leakage.

Normally, the mechanical connection between the coupling and the line is established by means of a connection area having a so-called serrated profile with undercut portions which define a mechanical locking means preventing removal. In order to achieve the necessary leakproofness, the connection area and the line end are joined by bonding or welding, in addition to or alternatively to the mechanical locking.

A method which is especially used for this purpose is friction welding, in the case of which the coupling and the line are caused to rotate relative to one another, whereby frictional heat is produced in the area of contact between the connection area and the line end. This has the effect that the connection area and the line end will melt in the boundary zones thereof so that a substance-to-substance bond will be formed in this region.

Friction welding is disadvantageous insofar as the connection area must have a specific contour for providing a suitable, i.e. the largest possible area of contact.

Another possibility of producing a hose connection is welding by means of a laser. For this purpose, one of the two components to be joined by welding, in particular the outer component, must be produced from a laser-transparent material so as to allow the contact area between the connection area and the line end to be melted.

For joining the line and the coupling by means of an adhesive, a thermosetting adhesive is normally used. This method is disadvantageous insofar as the coupling and the line must be heated to a substantially high temperature so as to obtain the activation temperature of the adhesive on the joining face between the connection area and the line end. This may result in destruction of the coupling and of the line, respectively, due to excessive heating. In addition, the curing of the adhesive is time- and energy-intensive.

It is therefore the object of the present invention to provide a coupling which allows lines to be connected easily and safely. It is a further object of the present invention to provide a line which is intended to be connected to a coupling and which can be connected thereto easily and safely. Furthermore, a method of producing such a coupling and such a line is to be provided. In addition, an arrangement is to be provided, in the case of which a coupling and a line, or two lines, are safely connected to one another, as well as a method for easily establishing and releasing line connections.

With regard to the coupling, the line and the arrangement, the above-mentioned objects are achieved by the subject matters of claims 1, 11, 19 and 20 according to the present invention. With regard to the method of producing the coupling and the line, respectively, and with regard to the method of connecting and disconnecting lines, the above-mentioned objects are achieved by the subject matters of claims 22, 29, 36, 37, 38 and 39 according to the present invention.

The present invention has the advantage that the coupling according to the present invention and the line according to the present invention set the stage for allowing local heating in the area of the joining face between the first connection area and the line end. For this purpose, the present invention provides a section, which, due to the fact that it is arranged in the first connection area and on the line end, respectively, is provided in the joining area between the connection area and the line end, in the joined condition of the coupling and of the line. Due to the energetically activatable particles, which are provided in said section according to the present invention, it is possible to introduce, especially by means of radiation, energy precisely in the joining area, where it will be absorbed by said energetically activatable particles. The particles emit the absorbed energy in the form of heat so that a locally limited heating of the section can take place in the joining area. The purposeful, limited heating of the section can be used for providing the temperatures required for the various connecting and disconnecting techniques. It is thus possible to provide an arrangement comprising a coupling and a line connected thereto, without any necessity of heating the arrangement in its entirety, whereby damage caused by excessive heating of the coupling and of the line, respectively, will be avoided. The same applies to arrangements comprising two lines, in which lines are connected directly without making use of an intermediate coupling.

A further advantage of the present invention is to be seen in the fact that the invention can be used in a flexible manner for producing a welded joint or an adhesive bond, simply by choosing a suitable material for the section having embedded therein the energetically activatable particles.

The same applies to the method according to the present invention. The invention is advantageous insofar as the line connections are established and disconnected by the same step, viz. the introduction of the arrangement in a magnetic or an electromagnetic field.

Preferably, the particles can be activated by magnetic or electromagnetic fields. The use of such activatable particles allows energy to be introduced in the joining area in a particularly effective manner, without thermally influencing the surrounding components.

If the section is to be used for producing a welded joint or an adhesive bond, said section can comprise a weldable material or a thermally activatable adhesive material.

According to a particularly preferred embodiment of the invention, the section comprises a foil. This has the advantage that the first connection area of the coupling or the line end of the line can be provided with said section in a particularly simple manner. The foil can be applied by a winding movement.

According to a further embodiment of the present invention, the section comprises a tubing, in particular a shrinkdown tubing. The thus formed section can be pushed onto the first connection area or the line end; if a shrinkdown tubing is used, the additional advantage is achieved that the section will be fixed in position by shrinking on. The coupling and the line can thus be joined more easily, since the shrinkdown tubing cannot be displaced.

The section is preferably implemented as a sleeve. The sleeve can be introduced in the reception area very easily, e.g. by pushing in, and facilitates the assembly and, in the final analysis, the production of the line connection.

Furthermore, the first connection area and the line end, respectively, can be implemented as a 2-component part; in this case, the section is applied by means of injection moulding.

In this embodiment of the present invention, the section forms a layer which is firmly connected to the connection area and the line end, respectively, whereby the coupling and the line can more easily be assembled.

Another possibility of providing said section on the connection area and the line end, respectively, is to be seen in that the section and the connection area or the line end are coextruded. Co-extrusion of the section and of the connection area or the line end offers a particularly simple production possibility, which, in addition, facilitates the assembly of the coupling and of the line.

Providing the section on an inner wall of the first connection area is one possibility of attaching said section to the first connection area of the coupling at such a position that it can be brought into contact with the line end of a line to be connected. Another possibility of providing the section in the above-described position is that the connection area comprises an inner connecting piece with an outer wall having said section provided thereon.

The invention will be explained in the following, by way of example and with further details, on the basis of schematic drawings, in which:

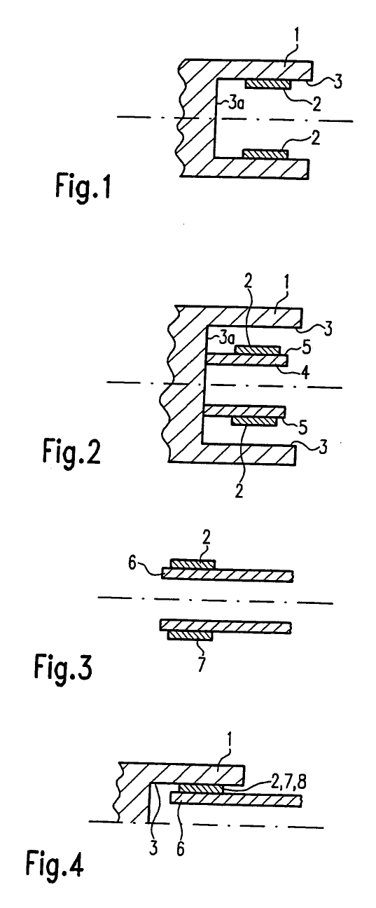

FIG. 1 shows a longitudinal section through the first connection area of a coupling according to an embodiment of the present invention;

FIG. 2 shows a longitudinal section through the first connection area of a coupling according to a further embodiment of the present invention;

FIG. 3 shows a longitudinal section through the line end of a line according to an embodiment of the present invention;

FIG. 4 shows a longitudinal section through the first connection area and the line end of an arrangement comprising a coupling and a line;

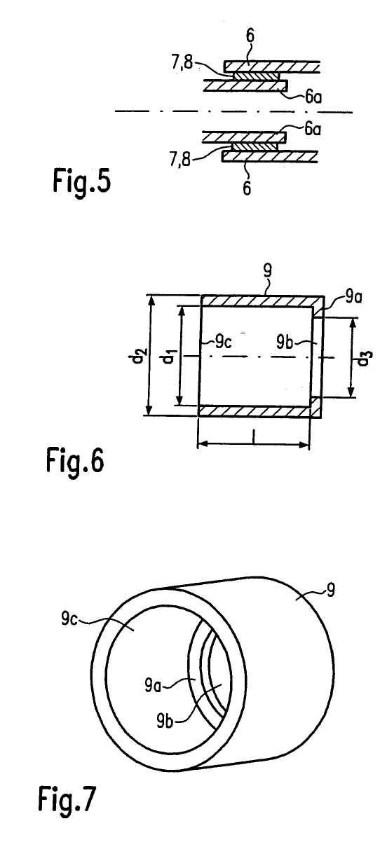

FIG. 5 shows a longitudinal section through an arrangement comprising two lines that are connected to one another;

FIG. 6 shows a longitudinal section through a sleeve that is adapted to be used for forming the section, and

FIG. 7 shows a perspective view of the sleeve according to FIG. 6.

FIG. 1 shows a first connection area 1 of a coupling, especially a quick coupling (quick connector) for connecting lines, in particular fluid-conducting lines, according to a first embodiment. This first connection area 1 is intended to be fixedly connected to the end of a line which is not shown in FIG. 1. The second connection area, which is not shown in FIG. 1, is connected to the first connection area 1 by a passage and is adapted to be releasably connected to the end of a second line, e.g. by a locking mechanism.

Such a coupling is predominantly used in the field of automobile industry for connecting fuel hoses. Other fields of use for such couplings are imaginable as well. Furthermore, the present invention is not limited to a coupling having two connection areas. It is also possible to connect the first connection area 1 to more than one further connection area by respective distribution ducts. In addition, the coupling according to the present invention can comprise further connection areas which are implemented in accordance with said first connection area 1.

The first connection area 1, which has a cylindrical inner wall 3 in the example shown in FIG. 1, is, at least sectionwise, provided with a section 2. The section 2 can be arranged such that it extends over the whole circumference of the inner wall 3 or over certain circumferentially distributed portions of said inner wall 3. The arrangement of said section 2 on the inner wall 3 of the connection area 1 allows said section 2 to be brought into contact with the line end of a line, when said line is introduced in the coupling, said line end being not shown in FIG. 1. The section 2 follows substantially the contour of the connection area 1, in the present case the cylindrical inner wall 3. This allows insertion of a suitably shaped line end.

According to the present invention, the section 2 has embedded therein energetically activatable particles, which are not shown in the figures.

The mean particle size can be in the micrometer range. It proved to be particularly advantageous when the mean particle size is in the nanometer range, i.e. in a range between a few nanometers and >100 nm. The particle property of absorbing magnetic or electromagnetic radiation is obtained by using metallic, magnetic, ferrimagnetic, ferromagnetic, anti-ferromagnetic or superparamagnetic particles. The materials following hereinbelow can, in particular, be used for the energetically activatable particles:
MagSi®, produced by the firm of Degussa
MnZn ferrites
magnetite (Fe₃O₄)
iron and
strontium ferrite.

The coupling shown in FIG. 1 offers the prerequisite for producing a safe connection between the coupling and a line by means of bonding or welding, without any necessity of heating the whole arrangement, but, for adjusting the necessary process temperature, it will suffice to introduce the joined coupling and line into a magnetic induction field or a microwave field so that the particles contained in the section 2 will absorb the radiation energy and heat up. The heat generated in the particles is given off to the surrounding material of the section 2, which is heated in this way. When the aimed-at process temperature has been reached, the connection area 1 and the line end will be joined by welding or bonding, depending on the material of the section 2. During welding, the section 2 and the adjoining areas of the connection area 1 and of the line end are melted and, after having solidified, they form a substance to substance bond. When the section 2 is produced from a thermally activatable adhesive material, this adhesive material is cured by suitable heating by means of the energetically activatable particles, whereby an adhesive bond is formed.

FIG. 2 discloses a further embodiment of the coupling according to the present invention in which the connection area 1 comprises an inner connecting piece 4 with an outer wall 5. In this embodiment, the section 2 is provided on the outer wall 5 and can thus be brought into contact with a line end of a line to be connected, said line end being inserted in the connection area 1. In addition to the section 2, which is provided on the outer wall 5, a further section can be provided on the inner wall 3, which is located opposite the outer wall 5, so that the line end inserted in the connection area 1 is connected on both sides, i.e. on the inner and on the outer side.

FIG. 3 shows the line end 6 of a line according to an embodiment of the present invention, said line being suitable for connection to a coupling. On the outer wall of the line 6, a section 7 is provided, which is adapted to the contour of the line end 6. The section 7 can be provided on the line end over the whole circumference or in certain portions thereof. In addition, the section 7 comprises energetically activatable particles and corresponds, with regard to the composition of the material and the composition of the particles, to the section 2 disclosed in connection with FIG. 1.

The line shown in FIG. 3 can be used in combination with a conventional coupling. The line can, however, also be used in combination with the coupling shown in FIG. 2, whereby it is achieved that both joining faces (between the outer surface of the line and the inner wall 3 and the inner surface of the line and the outer wall 5) have the sections 2, 7 which have added thereto the energetically activatable particles.

FIG. 4 shows an arrangement according to an embodiment of the present invention, in which the connection area 1 has inserted therein the line end 6. In this arrangement, the section 2, 7 is disposed in the joining region between the inner wall 3 of the connection area 1 and the outer surface of the line end 6. This arrangement is exposed to a magnetic or an electromagnetic field so that the energetically activatable particles contained in said section 2, 7 and thus the material surrounding these particles will be locally heated. The connection area 1 and the line end 6 are joined by welding or bonding, in dependence upon the material chosen for the section 2, 7. Thus, a layer 8 is formed by means of which the connection area and the line end 6 are firmly connected.

FIG. 5 shows a further embodiment of the present invention, in which two line ends 6, 6a of two lines are connected directly, i.e. without an intermediate coupling. This embodiment is based on the same principle as the embodiment shown in FIG. 4, which concerns an arrangement comprising a coupling and a line. In the case of the direct connection of two lines shown in FIG. 5, the joining face, i.e. the area between the inner surface of the outer line end 6 and the outer surface of the inner line end 6a, has again arranged therein a section 7 and a layer 8, respectively. Just as in the case of the embodiment shown in FIG. 4, the outer line end 6 is pushed onto the inner line end 6a in such a way that the section 7 comprising the energetically activatable particles comes into contact with the respective line end 6, 6a in the area of the joining face. By introducing this arrangement in a magnetic or an electromagnetic field, the energetically activatable particles will be heated, whereby an adhesive bond or a welded joint, depending on the material chosen for the section, will be produced. Thus, a layer 8 is formed by means of which the two line ends 6, 6a are firmly connected.

The thickness of the sections 2, 7 and, in the final analysis, the thickness of the interconnecting layer 8 depends on the distance between the areas of the line end 6 and of the connection area 1 which are to be joined. This distance should be dimensioned such that, in the joined condition, the section 2, 7 abuts on both sides over the largest possible area on the respective wall of the connection area 1 and of the line end 6. It proved to be useful, when the thickness of the section 2, 7 is in the range of from 0.1 to 5 mm, preferably 0.5 to 3 mm, more preferably 0.5 to 1 mm. The thickness also depends on the nature of the section in question; when the section is implemented e.g. as a foil, small thicknesses, in particular thicknesses from 0.5 to 1 mm, are used. When a sleeve 9 is used as a section 2, 7, larger thicknesses are used.

The adhesive materials used are polyamides, the use of other thermoplastics or thermoplastic elastomers being, however, imaginable as well. A material that is suitable for welding is the material PA12 that can be used for the section 2, 7.

The section 2, 7 can be applied to the connection area 1 and the line end 6, respectively, either as a separate element or as a firmly connected layer.

The section 2, 7 can be implemented as a foil (separate element), which is applied to the respective component, e.g. by a suitable winding movement. The application of a foil is particularly suitable for the inner connecting piece 4 shown in FIG. 2 and the line end 6 shown in FIG. 3. The foil can be applied in the form of one section or in the form of a plurality of sections. It turned out that a one-sectioned application of the foil produces particularly good results, especially when the section has a thickness of from 0.5 mm to 1 mm. Foils provided with nano-scale particles are manufactured e.g. by the firms of Degussa and EMS-Chemie.

It is also possible to implement the section 2, 7 as a tubing (separate element), in particular as a shrinkdown tubing. This tubing can easily be inserted in the connection area 1 shown in FIG. 1 in such a way that it abuts on the inner wall 3. The coupling and line, respectively, shown in FIGS. 2 and 3 can be provided with the section 2, 7 by pushing the tubing onto the inner connecting piece 4 and the line end 6, respectively. Joining of the coupling and of the line will be facilitated by the use of a shrinkdown tubing, which is shrunk onto the respective component, whereby the tubing will be fixed. A displacement of the section 2, 7 during assembly will be avoided in this way.

In addition, the section 2, 7 can also be realized by using the sleeve 9 shown in FIG. 6, 7. The sleeve 9 is a plastics moulding which has embedded therein energetically activatable particles. The embedded particles correspond to the particles which have been explained in a general context in connection with the section 2. The implementation of the section 2, 7 as a sleeve 9 is based on the same principle as the implementation of the section 2, 7 as a foil or as a tubing, said sleeve 9 being arranged in the joining face between the components to be connected (connection area/line end or line end 6/line end 6a). Depending on the material chosen for the sleeve 9, a welded joint or an adhesive bond is produced in the area of the joining zone, said welded joint or adhesive bond being established due to the heating of the energetically activatable particles contained in the sleeve 9. The sleeve 9 has the advantage that there is no risk of displacement when the components to be connected are inserted into one another.

As can be seen in FIG. 6, 7, the sleeve 9 comprises a flange 9a, which extends radially inwards and which serves as a stop for a line end to be connected to the coupling, said line end being inserted into the sleeve 9 through the opening 9c. The sleeve 9 is inserted into the reception area 1 in such a way that the outer wall of the sleeve 9 abuts on the inner wall 3 of the connection area 1. The flange 9a will then abut on an axial end 3a of the connection area 1.

The axially extending wall thickness of the flange 9a can correspond to the wall thickness of the sleeve 9 (difference between the outer diameter d₂ and the inner diameter d₁). The wall thickness of the flange 9a may, however, also be smaller than or larger than the wall thickness of the sleeve 9. In addition, the distance d₁/2-d₃/2, i.e. the radial dimension of the flange 9a, corresponds to the wall thickness of the line to be connected. This has the effect that the opening 9b formed in the flange 9a terminates flush with the inner surface of the line to be connected.

According to a further embodiment, which is not shown, the flange 9a can extend radially outwards, so that the inner surface of the sleeve 9 abuts on the outer surface of the inner connecting piece.

The length l of the flange 9a determines the adhesive force.

Another possibility of applying the section 2, 7 to the connection area and the line end 6, respectively, is the possibility of applying the section 7 by means of injection moulding onto the connection area 1 and the line end 6, respectively, whereby a 2-component part will be formed. In this case, the section 2, 7 is, in the form of a layer, firmly connected to the connection area and the line end 6, respectively. Another possibility of applying the section 2, 7 is co-extrusion of said section 2, 7 and of the line end 6 or the connection area 1, in particular the inner connecting piece 4.

It follows that the present invention provides the prerequisite for joining a coupling, in particular a quick coupling, to a line by means of welding or bonding, the heat being produced locally and for a short period of time, whereby an energy-saving connection can be established, which prevents the components in question from being damaged.

In addition, the present invention provides not only the possibility of effectively interconnecting lines by means of an intermediate coupling, but also the possibility of establishing direct connections between two lines without the use of an intermediate coupling.

The present invention additionally provides the possibility of releasing adhesive bonds or welded joints between lines or between a coupling and a line in a simple way (debonding on command), and this is particularly advantageous with respect to the directive on end-of life vehicles. For this purpose, the connection is introduced in a magnetic or electromagnetic field, whereby the interconnecting layer 8, which has embedded therein suitable energetically activatable particles, is heated to the temperature required for releasing the connection.

The invention is particularly suitable for use in the field of fuel hose connections, but it can also be used in other fields where a safe connection of fluid-conducting lines is of importance.

1. A coupling for connecting lines, comprising a first connection area and at least one second connection area,
wherein
the first connection area is provided, at least sectionwise, with a section which is adapted to the contour thereof, said section comprising energetically activatable particles and being adapted to be brought into contact with a line end of one of the lines to be connected.

2. A coupling according to claim 1, wherein the particles can be activated by magnetic or electromagnetic fields.

3. A coupling according to claim 1, wherein the section comprises a weldable material or a thermally activatable adhesive material.

4. A coupling according to claim 1, wherein the section comprises a foil.

5. A coupling according to claim 1, wherein the section comprises a tubing, in particular a shrinkdown tubing.

6. A coupling according to claim 1, wherein the section is implemented as a sleeve.

7. A coupling according to claim 1, wherein the first connection area and the section are implemented as a 2-component part, the section being applied to said connection area by means of injection moulding.

8. A coupling according to claim 1, wherein the section and the first connection area are formed by co-extrusion.

9. A coupling according to claim 1, wherein the first connection area comprises an inner wall having the section provided thereon.

10. A coupling according to claim 1, wherein the first connection area comprises an inner connecting piece with an outer wall having the section provided thereon.

11. A line, in particular for connection to a coupling, including a line end,
wherein
the line end is provided, at least sectionwise, with a section which is adapted to the contour thereof, said section comprising energetically activatable particles.

12. A line according to claim 11, wherein the particles can be activated by magnetic or electromagnetic fields.

13. A line according to claim 11, wherein the section comprises a weldable material or a thermally activatable adhesive material.

14. A line according to claim 11, wherein the section comprises a foil.

15. A line according to claim 11, wherein the section comprises a tubing, in particular a shrinkdown tubing.

16. A line according to claim 11, wherein the section is implemented as a sleeve.

17. A line according to claim 11, wherein the line end and the section are implemented as a 2-component part, the section being applied to said line end by means of injection moulding.

18. A line according to claim 11, wherein the section and the line end are formed by co-extrusion.

19. An arrangement comprising a coupling, in particular a quick coupling, and a line,
wherein
the coupling and the line are connected by a layer which comprises energetically activatable particles.

20. An arrangement comprising two lines,
wherein
the two lines are connected by a layer which comprises energetically activatable particles.

21. An arrangement according to claim 19, wherein the layer comprises a weldable material or a thermally activatable adhesive material.

22. A method of producing a coupling, in particular a quick coupling, comprising a first connection area and at least one second connection area, wherein said first connection area is provided, at least sectionwise, with a section which comprises energetically activatable particles, and said section is adapted to the contour of said first connection area and arranged in such a way that it can be brought into contact with a line end of a line.

23. A method according to claim 22, wherein the first connection area is provided with a foil.

24. A method according to claim 23, wherein the foil is applied by winding movements.

25. A method according to claim 22, wherein the first connection area is provided with a tubing, in particular a shrinkdown tubing.

26. A method according to claim 22, wherein the first connection area has inserted therein a sleeve, said sleeve being especially inserted by pushing in.

27. A method according to claim 22, wherein the section is applied to the first connection area by means of injection moulding.

28. A method according to claim 22, wherein the first connection area and the section are formed by co-extrusion.

29. A method of producing a line, in particular for connection to a coupling, comprising a line end, wherein the line end is provided with a section comprising energetically activatable particles, and said section is adapted to the contour of the line end.

30. A method according to claim 29, wherein the line end is provided with a foil.

31. A method according to claim 30, wherein the foil is applied by a winding movement.

32. A method according to claim 29, wherein the line end is provided with a tubing, in particular a shrinkdown tubing.

33. A method according to claim 29, wherein a sleeve is attached to, in particular pushed onto the line end.

34. A method according to claim 29, wherein the section is applied to the line end by means of injection moulding.

35. A method according to claim 29, wherein the line end and the section are formed by co-extrusion.

36. A method of connecting lines, comprising the steps of
producing a plug-in connection between a first connection area of a coupling, in particular a quick coupling, and a line end of a line, said first connection area and/or the line end being provided with at least one section comprising energetically activatable particles, and said section being brought into contact with the first connection area and the line end, and
introducing the plug-in connection in a magnetic or an electromagnetic field.

37. A method of connecting lines, comprising the steps of
producing a plug-in connection between a line end of a line and a line end of a further line, a section comprising energetically activatable particles being arranged between the two line ends, and introducing the plug-in connection in a magnetic or an electromagnetic field.

38. A method of disconnecting lines, comprising the step of
introducing an arrangement, comprising a coupling, in particular a quick coupling, and a line into a magnetic or electromagnetic field, said coupling and said line being connected by means of welding or bonding by a layer which comprises energetically activatable particles.

39. A method of disconnecting lines, comprising the step of introducing an arrangement, comprising two lines into a magnetic or electromagnetic field, said two lines being connected by means of welding or bonding by a layer which comprises energetically activatable particles.
